(19) United States
(12) Patent Application Publication
(10) Pub. No.: US 2004/0102538 A1
(43) Pub. Date: May 27, 2004

(54) Method of producing flexible polyurethane foams

(76) Inventors: Bernd Bruchmann, Freinsheim (DE); Horst Binder, Lampertheim (DE); Heinz-Dieter Lutter, Diepholz (DE); Michael Kubler, Sandhausen (DE); Pamela Hoolt, Lembruch (DE)

Correspondence Address: BASF CORPORATION, LEGAL DEPARTMENT, 1609 BIDDLE AVENUE, WYANDOTTE, MI, 48192, US

(21) Appl. No.: 10/469,846

(22) PCT Filed: Feb. 28, 2002
(86) PCT No.: PCT/EP02/02132

(30) Foreign Application Priority Data
Mar. 5, 2001 (DE) 101 10 553.3

(51) Int. Cl. C08G 18/00

(52) U.S. Cl. 521/172

(57) ABSTRACT

The invention relates to a method of producing flexible polyurethane foams that have a density of not more than 100 g/l, by reacting: a) polyisocyanates with b) compounds with at least two hydrogen atoms that arm reactive with isocyanate groups. The inventive method is characterized in that the polyisocyanates (a) are aromatic di- or polysiocyanates and the compounds with at least two hydrogen atoms (b) that are reactive with isocyanate groups contain at least one acrylate polyol.

The present invention relates to a process for the preparation of flexible polyurethane foams by reacting polyisocyanates with compounds having at least two hydrogen atoms reactive with isocyanate groups.

Polyurethane foams have long been known and are widely described in the literature. They are usually prepared by reacting isocyanates with compounds having at least two hydrogen atoms reactive with isocyanate groups. Isocyanates used are generally aromatic di- and polyisocyanates, isomers of tolylene diisocyanate (TDI), isomers of diphenylmethane diisocyanate (MDI) and mixtures of diphenylmethane diisocyanate and polymethylenepolyphenylene polyisocyanates (crude MDI) being of most importance industrially.

In the case of low-density flexible polyurethane foams, in particular those having a density of less than 100, preferably less than 80, particularly preferably from 25 to 80, g/l, it is often difficult to bring the rigidity of the foam to a level desired by the market. This is currently remedied by adding polymer-modified polyols to the polyol component. Such filler-containing polyols (filler polyols) can be prepared, for example, by in situ polymerization of ethylenically unsaturated monomers, preferably styrene and/or acrylonitrile, in polyether alcohols (graft polyols). The polymer-modified polyether alcohols include polyetheralcohols containing polyurea dispersions (PHD polyols), which are preferably prepared by reacting amines with isocyanates in polyols. Furthermore, the solid-containing polyols based on polyisocyanate polyaddition with alkanolamines, i.e. PIPA polyols, may be mentioned. An overview of the filler polyols is given in the section Rohstoffe in Kunststoffhandbuch, Volume 7, Polyurethane, edited by Günter Oertel, Carl-Hanser-Verlag, Munich, 3rd Edition 1993, and DE 195 08 079 and DE 197 25 020.

However, these solid-containing or filler polyols have substantial disadvantages. On the one hand, the solid particles give rise to problems since they either settle out during storage or block filters of the polyol delivery pumps during the production of the PU foams; on the other hand, the polyols are not very reactive and require special catalysts during the foam preparation.

U.S. Pat. No. 3,284,415 describes the preparation of polyurethanes, in particular cellular and foamed polyurethanes, by reacting diisocyanates or polyisocyanates with compounds having at least two hydrogen atoms reactive with isocyanate groups, copolymers of ethylene and from 4 to 35% by weight of alkyl acrylates and/or hydroxyalkyl acrylates being used as compounds having at least two hydrogen atoms reactive with isocyanate groups. These ethylene/acrylate copolymers are used as the only polyol component. The diisocyanates used are in particular aromatic di- and polyisocyanates, such as tolylene diisocyanate, phenylene diisocyanate, diphenylmethane diisocyanate or diphenylmethane diisocyanate oligomers. By using the polyethylene acrylates, the mechanical properties of the polyurethanes, in particular the resilience and the impact strength at low temperatures, and the water resistance of the polyurethanes were improved.

DE-C-22 45 710 describes ethylenically unsaturated vinyl chloride copolymers which are liquid at room temperature and can be used as flameproofing agents in rigid polyurethane foams. However, no effect of the copolymers on the mechanical properties of the foams is mentioned.

It is an object of the present invention to provide polyurethane foams having a density of less than 100 g/l, which should have good mechanical properties, in particular rigidity, elongation and tensile strength, and which can be prepared using starting materials customary in polyurethane chemistry, it being possible to dispense with the use of filler polyols.

We have found that this object is achieved, according to the invention, by preparing polyurethane foams by reacting di- and/or polyisocyanates with compounds having at least two hydrogen atoms reactive with isocyanates, said compounds containing at least one polyacrylate polyol.

The present invention accordingly relates to a process for the preparation of flexible polyurethane foams by reacting

a) polyisocyanates with

b) compounds having at least two hydrogen atoms reactive with isocyanate groups,

wherein the polyisocyanates a) are aromatic di- and/or polyisocyanates and the compounds b) having at least two hydrogen atoms reactive with isocyanate groups contain at least one acrylate polyol.

The present invention furthermore relates to polyurethane foams which can be prepared by reacting

a) polyisocyanates with

b) compounds having at least two hydrogen atoms reactive with isocyanate groups,

wherein the polyisocyanates a) are aromatic di- and/or polyisocyanates and the compounds b) having at least two hydrogen atoms reactive with isocyanate groups contain at least one acrylate polyol.

The present invention furthermore relates to polyol mixtures containing at least one acrylate polyol and at least one further alcohol, preferably an at least difunctional polyether alcohol or a polyester alcohol.

The acrylate polyols used are preferably low molecular weight acrylate polyols, i.e. those whose number average molecular weight is not more than 12 000, preferably not more than 8 000, particularly preferably not more than 6 000, g/mol and not less than 400 g/mol. Below, the terms acrylate polyols and polycrylate polyols are used synonymously.

The acrylate polyols used according to the invention are prepared by polymerizing hydroxyl-functionalized (meth)acrylates, preferably by copolymerizing hydroxyl-functionalized (meth)acrylates with (meth)acrylates having no hydroxyl functional groups. Furthermore, they can also be prepared by copolymerizing said acrylate monomers with other aliphatic or aromatic, ethylenically unsaturated monomers, for example ethene, propene, butene, isobutene, diisobutene, acrylonitrile, acrylamide, acrolein, styrene, methylstyrene, divinylbenzene, maleic anhydride, vinyl esters of carboxylic acids or unsaturated carboxylic acids, such as maleic acid, fumaric acid or crotonic acid, or derivatives thereof.

Such copolymerizations can be carried out in reactors operated continuously or batchwise, for example kettles, annular gap reactors, Taylor reactors, extruders or tubular reactors.

Preferably chosen reaction conditions are those which lead to polymers having a low level of impurities. Thus, in the preparation of the acrylate polyols used according to the invention, the use of polymerization regulators is preferably dispensed with.

In the preparation of the acrylate polyols used according to the invention, polymerization is preferably effected at above 160° C. in the absence of polymerization regulators and at very low initiator concentrations. The process is preferably regulated in such a way that acrylate polyols having average molar masses (Mₙ) of not more than about 12 000 g/mol are present at the end of the reaction.

Homopolymers of hydroxyalkyl (meth)acrylates or copolymers of hydroxyalkyl (meth)acrylates with (meth)acrylic monomers having no hydroxyl functional groups are preferably suitable. In particular, halogen-free monomers are used in the preparation of the acrylate polyols used according to the invention.

The acrylate polyols used according to the invention are prepared in particular by polymerizing hydroxy-C1- to C8-alkyl (meth)acrylates, e.g. hydroxyethyl (meth)acrylate, hydroxypropyl (meth)acrylate or hydroxybutyl (meth)acrylate.

Particularly suitable acrylic monomers without OH groups, which, if required, may be used as comonomers, are aliphatic monomers containing olefinic double bonds and having a very wide range of chemical structures, for example alkenes of 2 to 6 carbon atoms, such as ethene, propene, butene or isobutene, acrylonitrile, acrylamide, acrolein, maleic anhydride, vinyl esters of carboxylic acids or unsaturated carboxylic acids, such as maleic acid, fumaric acid or crotonic acid, or derivatives thereof, and particularly preferably alkyl (meth)acrylates having C1 to C10 alkyl groups, for example n-hexyl (meth)acrylate, cyclohexyl (meth)acrylate, n-butyl (meth)acrylate, propyl (meth)acrylate, ethyl (meth)acrylate, methyl (meth)acrylate, ethylhexyl (meth)acrylate and/or hexanediol di(meth)acrylate. Said monomers can be used individually or in any desired mixtures with one another.

The acrylate polyols used according to the invention are preferably prepared by copolymerizing C1- to C8-hydroxyalkyl (meth)acrylates with the above-described (meth)acrylic monomers having no OH functional groups, it being possible to combine different hydroxyalkyl (meth)acrylates as desired with the (meth)acrylates having no OH functional groups. Preferably, the OH-containing monomers are used in concentrations of from 5 to 95, particularly preferably from 10 to 80, mol %.

In a particularly advantageous embodiment of the invention, the acrylate polyols are prepared by copolymerizing C1- to C8-hydroxyalkyl (meth)acrylates with alkyl (meth)acrylates having C1- to C10-alkyl groups.

The number average molecular weight (Mₙ) of the acrylate polyols used according to the invention are particularly preferably not more than 6 000 g/mol, the average OH functionalities are from 2 to 20 and the OH numbers are from 100 to 500 mg KOH/g. In the case of higher molecular weights and higher functionalities, the acrylate polyols are too viscous or solid and therefore can be processed in polyurethane systems only with difficulty. Moreover, the polyurethanes thus prepared have inadequate mechanical properties, owing to the very high crosslinking.

The polyacrylate alcohols are preferably added in an amount of 0.1-50, preferably 0.5-40, particularly preferaby 1-30, parts by weight, based on 100 parts by weight of the compounds b) having at least two hydrogen atoms reactive with isocyanate groups. Above these limits, the degree of crosslinking increases dramatically and the flexible foams lose their typical resilient properties.

Particularly suitable compounds b) which have at least two active hydrogen atoms and can be used together with the acrylate polyols used according to the invention are polyester alcohols and preferably polyether alcohols having an average functionality of from 2 to 8, in particular from 2 to 6, preferably from 2 to 4, and an average molecular weight of from 400 to 10 000, preferably from 1 000 to 8 000, g/mol.

The polyether alcohols can be prepared by known processes, generally by a catalytic addition reaction of alkylene oxides, in particular ethylene oxide and/or propylene oxide, with H-functional initiator substances, or by condensation of tetrahydrofuran. H-functional initiator substances used are in particular polyfunctional alcohols and/or amines. Water, dihydric alcohols, for example ethylene glycol, propylene glycol or butanediols, trihydric alcohols, for example glycerol or trimethylolpropane, and alcohols having a higher functionality, such as pentaerythritol or sugar alcohols, for example sucrose, glucose or sorbitol, are preferably used. Preferably used amines are aliphatic amines of up to 10 carbon atoms, for example ethylenediamine, diethylenetriamine or propylenediamine, and amino alcohols, such as ethanolamine or diethanolamine. The alkylene oxides used are preferably ethylene oxide and/or propylene oxide, an ethylene oxide block frequently being added at the chain end in the case of polyether alcohols which are used for the preparation of flexible polyurethane foams. Catalysts used in particular in the addition reaction of the alkylene oxides are basic compounds, potassium hydroxide being of most industrial importance here. If the content of unsaturated components in the polyether alcohols is to be low, multimetal cyanide compounds, i.e. DMC catalysts, may also be used as catalysts.

For the preparation of flexible foams and integral foams, in particular difunctional and/or trifunctional polyether alcohols are used.

Difunctional and/or trifunctional polyether alcohols which have primary hydroxyl groups, in particular those having an ethylene oxide block at the chain end or those based only on ethylene oxide, are preferably used for the preparation of flexible foams by the novel process.

The compounds having at least two active hydrogen atoms include the chain extenders and crosslinking agents, which, if required, may be concomitantly used. The chain extenders and crosslinking agents used are preferably difunctional and trifunctional alcohols having molecular weights of less than 400, in particular from 60 to 150, g/mol. Examples are ethylene glycol, propylene glycol, diethylene glycol, 1,4-butanediol, glycerol and trimethylolpropane. Diamines, too, can be used as crosslinking agents. If chain extenders and crosslinking agents are used, the amount thereof is preferably up to 5% by weight, based on the weight of the compounds having at least two active hydrogen atoms.

The polyisocyanates used may be the conventional and known aromatic di- and polyisocyanates. Examples of aromatic di- or polyisocyanates are tolylene 2,4-diisocyanate (2,4-TDI), tolylene 2,6-diisocyanate (2,6-TDI)., diphenylmethane 2,4′-diisocyanate (2,4′-MDI), diphenylmethane 4,4′-diisocyanate (4,4′-MDI), polyphenylpolymethylene polyisocyanates, as prepared by condensation of aniline and formaldehyde and subsequent phosgenation (polymer MDI), p-phenylene diisocyanate, tolidene diisocyanate, xylylene diisocyanate and naphthylene 1,5-diisocyanate (NDI).

Together with or instead of these monomeric isocyanates or mixtures thereof, oligoisocyanates and polyisocyanates prepared therefrom, i.e. prepolymers, in particular based on TDI and MDI, are preferably used. These oligoisocyanates or polyisocyanates can be prepared from said di- or polyisocyanates or mixtures thereof by linkage by means of urethane, allophanate, urea, biuret, uretdione, amido, isocyanurate, carbodiimide, uretonomine, oxadiazinetrione or iminooxadiazinedione structures. TDI or MDI polymers having urethane, allophanate, carbodiimide, uretonomine, biuret or isocyanurate groups are preferably used here.

The novel process can be carried out with the concomitant use of further starting materials, in particular catalysts, blowing agents and assistants and/or additives, about which the following may be stated specifically:

Catalysts used for the preparation of the novel polyurethane foams are the conventional and known polyurethane formation catalysts, for example organic tin compounds, such as tin diacetate, tin dioctanoate or dibutyltin dilaurate and/or strongly basic amines, such as diazabicyclooctane, diazabicyclononane, diazabicycloundecane, triethylamine, pentamethyldiethylenetriamine, tetramethyldiaminoethyl ether, imidazoles or preferably triethylenediamine or bis(N,N-dimethylaminoethyl) ether. The catalysts are preferably used in an amount of from 0.01 to 10, preferably from 0.05 to 5, % by weight.

A blowing agent preferably used for the preparation of the polyurethane foams is water, which reacts with the isocyanate groups with liberation of carbon dioxide. Together with or instead of water, physical blowing agents, for example carbon dioxide, hydrocarbons, such as n-pentane, isopentane, cyclopentane or cyclohexane, or halogenated hydrocarbons, such as tetrafluoroethane, pentafluoropropane, heptafluoropropane, pentafluorobutane, hexafluorobutane or dichloromonofluoroethane, may also be used. The amount of the physical blowing agent is preferably from 1 to 15, in particular from 1 to 10, % by weight, and the amount of water is preferably from 0.5 to 10, in particular from 1 to 5, % by weight.

Assistants and/or additives used are, for example, surfactants, foam stabilizers, cell regulators, external and internal lubricants, fillers, flameproofing agents, pigments, hydrolysis stabilizers and fungistatic and bacteriostatic substances.

In industrial production of polyurethane foams, it is usual to combine the compounds b) having at least two active hydrogen atoms and the further feedstocks as well as assistants and/or additives before the reaction to give a polyol component.

Further information on the starting materials used is to be found, for example, in Kunststoffhandbuch, Volume 7, Polyurethane, edited by Günter Oertel, Carl-Hanser-Verlag, Munich, 3rd Edition 1993.

For the preparation of the novel polyurethanes, the organic polyisocyanates a) are reacted with the compounds b) having at least two active hydrogen atoms and said blowing agents, catalysts and assistants and/or additives (polyol component), the acrylate polyols used according to the invention preferably being added to the polyol component.

In the preparation of the novel polyurethanes, isocyanate component and polyol component are combined in an amount such that the ratio of the number of equivalents of isocyanate groups to the sum of the active hydrogen atoms is from 0.6:1 to 1:1.4, preferably from 0.7:1 to 1:1.2.

The preparation of the polyurethane foams is preferably effected by the one-shot process, for example with the aid of the high pressure or low pressure technique. The foams can be prepared in open or closed metallic molds or by the continuous application of the reaction mixture to belt lines for the production of slabstock foams.

It is particularly advantageous to employ the two-component process in which, as stated above, a polyol component and an isocyanate component are prepared and foamed. The components are preferably mixed at from 15 to 120° C., preferably from 20 to 80° C., and introduced into the mold or onto the belt line. The temperature in the mold is generally from 15 to 120° C., preferably from 30 to 80° C. If acrylate polyols having a viscosity above 10 000 mPa.s, measured at 23° C., are used, it is advantageous to predilute the acrylate with a relatively low-viscosity OH component of the polyol mixture at about 50° C. before it is added to the polyol mixture.

The acrylate polyols used according to the invention permit the preparation of resilient and viscoelastic flexible foams having densities of less than 100 g/l and excellent mechanical properties, for example very good elongation, tensile strength and rigidity, without having to rely on the use of filler polyols, which have the abovementioned disadvantages.

The examples which follow illustrate the invention.

Table 1 shows examples of polyacrylate polyols which can be used for the preparation of the novel foams.

TABLE 1
Examples of polyacrylate polyols

| | | Number | | |
|---|---|---|---|---|
| Poly- | Monomer | average | Poly- | |
| acrylate | composition | molar mass | dispersity | OH number |
| No. | (mol %) | (g/mol) | (M_{w}Mₙ) | (mg KOH/g) |
| 1 | HEMA/BA | 1719 | 1.63 | 299 |
| | 75:25 | | | |
| 2 | HEA/BA | 1889 | 4.79 | 121 |
| | 25:75 | | | |
| 3 | HEA/BA | 1751 | 2.15 | 241 |
| | 50:50 | | | |
| 4 | HEA/BA | 2160 | 2.22 | 241 |
| | 50:50 | | | |
| 5 | HEA/BA/HDDA | 1476 | 4.46 | 241 |
| | 50:47:3 | | | |
| 6 | HEA/EHA/HDDA | 1289 | 2.52 | 241 |
| | 50:47:3 | | | |

HEMA: 2-Hydroxyethyl methacrylate
BA: n-Butyl acrylate
HEA: 2-Hydroxyethyl acrylate
HDDA: Hexanediol diacrylate
EHA: 2-Ethylhexyl acrylate

First, the polyols components were prepared from the compounds stated in parts by weight in tables 2 and 3. These polyol components and the amounts of the isocyanate component which are likewise stated in parts by weight in tables 2 and 3 were combined, homogenized using a stirrer and introduced into a mold open at the top, heated to 60° C. and having the dimensions 40×40×40 cm. The resulting foams were cured at room temperature (23° C.) for 24 hours and then measured.

TABLE 2
Examples of the use of acrylate polyols in highly
resilient MDI foam formulations

| | Example | | | | | | |
|---|---|---|---|---|---|---|---|
| | 1 | | | | | | |
| | (Compari- | | | | | | |
| | son) | 2 | 3 | 4 | 5 | 6 | 7 |
| Polyol component | | | | | | | |
| Lupranol ® 2091 | 96 | 96 | 96 | 96 | 96 | 96 | 96 |
| Lupranol ® 2047 | 4 | 4 | 4 | 4 | 4 | 4 | 4 |
| Polyacrylate No. 2 (Tab. | | 5 | 10 | 15 | | | |
| 1) | | | | | | | |
| Polyacrylate No. 4 (Tab. | | | | | 5 | 10 | 15 |
| 1) | | | | | | | |
| Texacat ZF 24 | 0.4 | 0.4 | 0.4 | 0.4 | 0.4 | 0.4 | 0.4 |
| Diethanolamine 100% | 0.24 | 0.24 | 0.24 | 0.24 | 0.24 | 0.24 | 0.24 |
| DBTL | 0.08 | 0.08 | 0.08 | 0.08 | 0.08 | 0.08 | 0.08 |
| Tegostab ® B 8728 | 0.1 | 0.1 | 0.1 | 0.1 | 0.1 | 0.1 | 0.1 |
| Water | 2.6 | 2.6 | 2.6 | 2.6 | 2.6 | 2.6 | 2.6 |
| Isocyanate component | 54.2 | 55.8 | 57.5 | 59.1 | 57.5 | 60.8 | 64.1 |
| Lupranat ® VP 9288 | | | | | | | |
| Index | 97 | 97 | 97 | 97 | 97 | 97 | 97 |
| Density (kg/m³) according | 49.4 | 52.5 | 55.4 | 57.5 | 53.1 | 56.2 | 64.8 |
| to DIN EN ISO 845 | | | | | | | |
| Tensile strength (kPa) | 57 | 69 | 74 | 81 | 72 | 86 | 101 |
| (according to DIN 53571) | | | | | | | |
| Elongation (%) | 98 | 98 | 98 | 99 | 86 | 91 | 81 |
| (according to DIN 53571) | | | | | | | |
| Compressive strength (kPa) | 3.7 | 4.4 | 4.7 | 5.4 | 5.2 | 6.6 | 9.5 |
| at 40% | | | | | | | |
| (according to DIN EN ISO | | | | | | | |
| 3386) | | | | | | | |

In comparison with the standard system (example 1), the addition of acrylate polyols substantially improves the tensile strength and the compressive strength of the foams.

TABLE 3
Examples of the use of acrylate polyols in TDI foam
formulations

| | Example | | | | | | | | |
|---|---|---|---|---|---|---|---|---|---|
| | 8 | | | | | | | | |
| | (Compari- | | | | | | | | |
| | son) | 9 | 10 | 11 | 12 | 13 | 14 | 15 | 16 |
| Polyol | | | | | | | | | |
| component | | | | | | | | | |
| Lupranol ® | 25 | | | | | | | | |
| 4700 | | | | | | | | | |
| Lupranol ® | 75 | 100 | 100 | 100 | 100 | 100 | 100 | 90 | 100 |
| 2080 | | | | | | | | | |
| Lupranol ® | | | | | | | | 10 | |
| 2047 | | | | | | | | | |
| Polyacrylate | | 5 | 10 | 15 | 20 | | | | |
| No. 2 (Tab. | | | | | | | | | |
| 1) | | | | | | | | | |
| Polyacrylate | | | | | | 5 | 10 | 15 | 20 |
| No. 4 (Tab. 1) | | | | | | | | | |
| Lupragen N 201 | 0.1 | 0.1 | 0.1 | | | 0.1 | | | 0.3 |
| Lupragen N 206 | 0.04 | 0.04 | 0.04 | 0.15 | 0.15 | 0.04 | 0.15 | 0.15 | 0.15 |
| Tegostab ® B | 0.95 | 0.95 | 0.95 | 0.95 | 0.5 | 0.95 | 0.5 | 0.50 | 0.5 |
| 4900 | | | | | | | | | |
| Kosmos 29 | 0.24 | 0.24 | 0.1 | 0.1 | 0.05 | 0.1 | 0.02 | 0.05 | |
| Water | 2.9 | 2.9 | 2.9 | 2.9 | 2.9 | 2.9 | 2.9 | 2.9 | 2.9 |
| Isocyanate | 39.8 | 42.0 | 43.1 | 44.1 | 45.2 | 43.1 | 45.2 | 47.2 | 49.8 |
| component | | | | | | | | | |
| Lupranat ® T | | | | | | | | | |
| 80 A | | | | | | | | | |
| Index | 115 | 115 | 115 | 115 | 115 | 115 | 115 | 115 | 115 |
| Density | 32.5 | 32.6 | 35.5 | 34.6 | 39.0 | 36.4 | 36.0 | 34.5 | 34.3 |
| (kg/m³) | | | | | | | | | |
| according to | | | | | | | | | |
| DIN EN ISO 845 | | | | | | | | | |
| Tensile | 79 | 79 | 79 | 77 | 84 | 85 | 86 | 92 | 69 |
| strength (kPa) | | | | | | | | | |
| (according to | | | | | | | | | |
| DIN 53571) | | | | | | | | | |
| Elongation (%) | 100 | 117 | 117 | 116 | 117 | 112 | 111 | 91 | 69 |
| (according to | | | | | | | | | |
| DIN 53571) | | | | | | | | | |
| Compressive | 5.6 | 4.8 | 4.5 | 4.4 | 4.7 | 5.6 | 4.8 | 5.3 | 6.2 |
| strength (kPa) | | | | | | | | | |
| at 40% | | | | | | | | | |
| (according to | | | | | | | | | |
| DIN EN ISO | | | | | | | | | |
| 3386) | | | | | | | | | |

In comparison with a standard system formulated using filler polyol (example 8), improved tensile strengths and elongations are obtained in the case of the novel foams with comparable densities. The compressive strength of the foams is at a comparably high level.

Definition of the feedstocks:

| | |
|---|---|
| Lupranol ® 2091: | Polyoxypropylenepolyoxyethylenetriol, |
| | hydroxyl number 28 mg KOH/g |
| Lupranol ® 2047: | Polyoxypropylenepolyoxyethylenetriol, |
| | hydroxyl number 42 mg KOH/g |
| Lupranol ® 2080: | Polyoxypropylenepolyoxyethylenetriol, |
| | hydroxyl number 48 mg KOH/g |
| Lupranol ® 4700: | Graft polyetherpolyol, based on |
| | acrylonitrile/styrene, hydroxyl number 29 mg |
| | KOH/g, solids content: 40%, viscosity 5 000 |
| | mPas (25° C.) |
| Lupranat ® T 80: | Tolylene diisocyanate, isomer mixture, NCO |
| | content = 48% by weight |
| Lupranat ® VP 9288: | Modified MDI polyisocyanate, NCO content = |
| | 28% by weight, viscosity 70 mPas (25° C.) |
| Lupragen ® N 201: | Diazabicyclooctane, 33% strength in |
| | dipropylene glycol |
| Lupragen ® N 206: | Bis(N,N-dimethylaminoethyl) ether, 70% |
| | strength in dipropylene glycol |
| Tegostab ® B 8728: | Stabilizer, Th. Goldschmidt |
| Tegostab ® B 4900: | Silicone stabilizer, Th. Goldschmidt |
| Kosmos ® 29: | Tin(II) octanoate, Th. Goldschmidt. |
| Texacat ® ZF 24: | Bis(N,N-dimethylaminoethyl) ether, 23% |
| | strength in dipropylene glycol, Texaco |
| DBTL: | Dibutyltin dilaurate. |

We claim:

1. A process for the preparation of flexible polyurethane foams having a density of less than 100 g/l, by reacting
a) polyisocyanates with
b) compounds having at least two hydrogen atoms reactive with isocyanate groups,
wherein the polyisocyanates a) are aromatic di- or polyisocyanates and the compounds b) having at least two hydrogen atoms reactive with isocyanate groups contain at least one acrylate polyol prepared by polymerization of hydroxyl-functionalized (meth)acrylates or by copolymerization of hydroxyl-functionalized (meth)acrylates with monomers having no hydroxyl functional groups, containing olefinic double bonds and selected from the group consisting of propene, butene, isobutene, diisobutene, acrylonitrile, acrylamide, acrolein, styrene, methylstyrene, divinylbenzene, maleic anhydride, vinyl esters of carboxylic acids or unsaturated carboxylic acids, for example maleic acid, fumaric acid or crotonic acid, or derivatives thereof and (meth)acrylates having no hydroxyl functional groups.

2. A process as claimed in claim 1, wherein the acrylate polyols have an average molecular weight Mₙ of not more than. 12 000 g/mol.

3. A process as claimed in claim 1, wherein the acrylate polyols have an average molecular weight Mₙ of not more than 8 000 g/mol.

4. A process as claimed in claim 1, wherein the acrylate polyols have an average molecular weight Mₙ of not more than 6 000 g/mol.

5. A process as claimed in claim 1, wherein the acrylate polyols are prepared by polymerization of hydroxyl-C1- to C8-alkyl (meth)acrylates.

6. A process as claimed in claim 1, wherein the acrylate polyols are prepared by copolymerization of hydroxy-C1- to C8-alkyl (meth)acrylates with alkyl (meth)acrylates having C1 to C10 alkyl groups.

7. A process as claimed in claim 1, wherein the compounds b) having at least two hydrogen atoms reactive with isocyanate groups contain at least one acrylate polyol and at least one polyether alcohol or polyester alcohol.

8. A process as claimed in claim 1, wherein acrylate polyols are used in an amount of 0.1-50 parts by weight, based on 100 parts by weight of the compounds b) having at least two hydrogen atoms reactive with isocyanate groups.

9. A process as claimed in claim 1, wherein acrylate polyols are used in an amount of 0.5-40 parts by weight, based on 100 parts by weight of the compounds b) having at least two hydrogen atoms reactive with isocyanate groups.

10. A process as claimed in claim 1, wherein acrylate polyols are used in an amount of 1-30 parts by weight, based on 100 parts by weight of the compounds b) having at least two hydrogen atoms reactive with isocyanate groups.

11. A process as claimed in claim 1, wherein the polyisocyanates a) used are tolylene diisocyanate, diphenylmethane diisocyanate, polyphenylpolymethylene polyisocyanate, phenylene diisocyanate, xylylene diisocyanate, naphthylene diisocyanate, tolidine diisocyanate or mixtures of said isocyanates.

12. A process as claimed in claim 1, wherein the polyisocyanates a) were modified by incorporation of urethane, allophanate, urea, biuret, uretdione, amido, isocyanurate, carbodiimide, uretonimine, oxadiazinetrione or iminooxadiazinedione structures.

13. A process as claimed in claim 1, wherein the polyisocyanates a) were modified by incorporation of urethane, allophanate, uretdione, carbodiimide, uretonimine, biuret or isocyanurate structures.

14. A polyurethane foam which can be prepared as claimed in any one of claims 1 to 13.
